(19) United States
(12) Patent Application Publication
(10) Pub. No.: US 2014/0092365 A1
(43) Pub. Date: Apr. 3, 2014

(54) SPACE IMAGE FORMING ELEMENT, METHOD OF MANUFACTURING THE SAME, DISPLAY DEVICE, AND TERMINAL

(71) Applicant: NLT TECHNOLOGIES, LTD., Kawasaki (JP)

(72) Inventors: Kunihiro SHIOTA, Kawasaki (JP); Ken Sumiyoshi, Kawasaki (JP)

(73) Assignee: NLT TECHNOLOGIES, LTD., Kawasaki (JP)

(21) Appl. No.: 14/038,179

(22) Filed: Sep. 26, 2013

(30) Foreign Application Priority Data
Sep. 28, 2012 (JP) 2012-218595
Aug. 6, 2013 (JP) 2013-163650

(51) Int. Cl. G02B 27/22

(52) U.S. Cl. CPC G02B 27/2221
USPC 353/10; 156/150; 205/122

(57) ABSTRACT

To provide a space image forming element realizing higher reflectance and larger area by making aperture ratio and transmittance higher and a method of manufacturing the same, thereby realizing high reflectance and, as a result, formation of an image having high brightness in the air. In a space image forming element of the present invention, a light transmission region is configured by a transparent pattern formed by exposure process using a transparent resist. By forming a metal layer between adjacent transparent patterns, a mirror-face region is formed in the interface between a side wall of the transparent pattern and the metal layer. The metal layer has a two-layer structure. The second metal layer is formed by electroplating using the metal in the first layer as an electrode.

### TECHNICAL FIELD

The present invention relates to a space image forming element for displaying an image in the air by, using reflection of light by two mirror-face elements which are arranged in an array and are orthogonal to each other, forming an image of reflection light in a position which is plane-symmetrical to a light source, and a method of manufacturing the same. The invention further relates to a display device and a terminal using a space image forming element manufactured by the method of manufacturing the space image forming element.

### BACKGROUND ART

3D display devices are used as display devices of various information processing terminals such as a TV, a portable terminal, and a portable game device. Recently, a liquid crystal display device capable of displaying a glasses-free 3D image is in practical use.

There is a case that the user comes to have eyestrain due to long-time viewing in those 3D display devices using binocular parallax, and a 3D display system having less burden on viewers is being demanded.

To address the demand, in patent literature 1, 2, and 3 listed below, there is proposed a system for displaying an image in the air, as illustrated in FIGS. 2A and 2B, by forming an image of reflection light in a position which is plane-symmetrical to a light source 45 using reflection of light of two mirror-face elements (two-face-corner reflector array) which are arranged in an array and orthogonal to each other.

In a 3D display system using binocular parallax, an object to be visually recognized is a virtual image. On the other hand, a 3D display image by the two-face-corner reflector array is a real image, so that feeling of fatigue of the eyes and brain is reduced.

Examples of a space image forming element used in the system include a configuration that a plurality of rectangular holes penetrating in the thickness direction are formed in a predetermined base and inner walls of each of the holes are formed by mirror faces which are orthogonal to each other, and a configuration that side wall faces of a transparent structure formed on a light transmission substrate are formed by mirror faces.

To obtain a bright image by increasing the brightness of reflection light, high reflectance needs to be realized. To realize high reflectance, it is effective to increase the aperture ratio determined by the ratio of the through holes in a base face, the transparent structure, or the like. For this purpose, the distance of neighboring through holes or transparent structures needs to be made shorter.

### CITATION LIST

### Patent Literature

Patent Literature 1: Japanese Patent Publication No. 4,734,652
Patent Literature 2: WO 2007/116639
Patent Literature 3: Japanese Unexamined Patent Application Publication No. 2009-229905

### SUMMARY OF INVENTION

### Technical Problem

However, as illustrated in FIGS. 3A and 3B, in the configuration of a space image forming element 5 used in the system, in which a plurality of through holes 7 penetrating in the thickness direction are formed in a predetermined base 6 and the inner wall of each of the holes is formed by mirror faces which are orthogonal to each other, due to limitation of process precision for forming the through holes 7 and a substrate size which can be dealt while assuring precision, the size of the base 6 as a component of the element is limited to small size.

In addition, since miniaturization of the through holes 7 by processing is limited, the aperture ratio determined by the ratio of the through holes 7 in the plane of the base 6 also becomes low and, as a result, a problem such that reflectance also becomes low occurs.

The configuration that the side wall faces of the transparent structure formed on the light transmission substrate are formed by mirror faces has a problem such that the incident angle of light is limited in order to assure high reflectance in a state where the side wall faces are transparent.

As illustrated in FIG. 5, in the case of forming a metal film on the inner wall face by sputtering or the like, a thick metal film 8 is adhered around the opening at the time of film formation by sputtering. Consequently, when the distance between the adjacent transparent layers 2 becomes shorter, problems occur such that the film is formed only around the surface and a no-film formation region 9 is formed and that a metal film 10 is formed also on the surface of the transparent layer as illustrated in FIG. 6 and transmittance decreases.

An object of the present invention is, therefore, to provide a space image forming element realizing higher reflectance and larger area by making aperture ratio and transmittance higher and a method of manufacturing the same, thereby realizing high reflectance and formation, in the air, of an image having high brightness obtained as a result of the high reflectance.

### Solution to Problem

To solve the problems, a method of manufacturing a space image forming element of the present invention includes: a step of forming a transparent photosensitive resin on a transparent substrate on which a first conductor is formed; a step of forming a light transmission region made by patterning the transparent photosensitive resin, on the transparent substrate other than a place where the first conductor is formed, by ultraviolet light irradiation to a face opposite to the transparent substrate face obtained by forming the transparent photosensitive resin and a subsequent developing process; and a step of forming a second conductor on the first conductor and between light transmission region patterns by electroplating using the first conductor as a cathode.

In the method of manufacturing a space image forming element of the present invention, the first conductor has shielding property from ultraviolet rays.

In the method of manufacturing a space image forming element of the present invention, the first conductor is made of a metal, and the metal is nickel, aluminum, chromium, or an alloy whose main component is any of the metals.

In the method of manufacturing a space image forming element of the present invention, the second conductor is a metal, and the metal is nickel, nickel palladium, or nickel cobalt.

Further, in the method of manufacturing a space image forming element of the present invention, a cover layer is disposed on the surface of the light transmission region and the second conductor, and the surface of the cover layer has a flat shape.

The cover layer in the space image forming element is made of a transparent resin having the same refractive index as that of the light transmission region.

A space image forming element of the present invention is manufactured by the above-described manufacturing method.

### Advantageous Effects of Invention

In the present invention, a transparent photosensitive resin is formed on a transparent substrate on which a first conductor is formed. By ultraviolet light irradiation to a face opposite to the transparent substrate face obtained by forming the transparent photosensitive resin and a subsequent developing process, it is possible to form a light transmission region disposed on a first conductor, which is disposed on the surface of the transparent substrate and has a predetermined plane pattern shape, and a region in which the first conductor is not formed.

Although a pattern having high aperture ratio cannot be conventionally formed because of mechanical process, a fine pattern can be formed by using photolithography process as in the present invention.

Further, by electroplating using the first conductor as a cathode and forming the second conductor on the first conductor and between the light transmission region patterns, a structure that the light transmission region, the first conductor, and the second conductor disposed on the surface of the first conductor are disposed in an array shape on the surface of the transparent substrate can be obtained.

Since a precise film can be formed in a fine pattern in the present invention as described above, the interface between the light transmission region and the second conductor becomes a mirror face having high reflectance. In addition, a precise metal layer can be formed to a transparent photosensitive resin having high aspect ratio.

Consequently, a high-reflectance space image forming element can be realized. Using the space image forming element described above allows formation of an image having high brightness in the air can be realized.

As described above, according to the present invention, finer pattern, higher aperture ratio of the light transmission region, higher transmittance, and larger area can be simultaneously realized, and higher reflectance and formation of an image having high brightness in the air obtained as a result of the higher reflectance can be realized.

### BRIEF DESCRIPTION OF DRAWINGS

FIG. 1 is a cross-section view schematically illustrating the structure of a space image forming element of a first embodiment of the present invention;

FIGS. 2A and 2B are cross-section views illustrating the operation principle of a space image forming element in the technical field of the present invention, and are a top view and a side view, respectively;

FIGS. 3A and 3B are diagrams schematically illustrating the structure of a conventional space image forming element in the technical field of the present invention;

FIG. 4 is a diagram schematically illustrating formation of a metal film on an inner wall face of the space image forming element of the first embodiment of the present invention;

FIG. 5 is a cross-section view illustrating an outline of a problem in the case of forming a metal film by sputtering on the inner wall face of the space image forming element of the first embodiment of the present invention;

FIG. 6 is a cross-section view schematically illustrating another problem in the case of forming a metal film by sputtering on the inner wall face of the space image forming element in the first embodiment of the present invention;

FIG. 7 is a manufacture process drawing illustrating an outline of process of manufacturing the space image forming element of the first embodiment of the present invention;

FIG. 8 is a cross-section view illustrating an outline of the structure of a space image forming element of a second embodiment of the present invention;

FIG. 9 is a cross-section view illustrating an outline of an effect of the space image forming element of the second embodiment of the present invention;

FIGS. 10A and 10B are cross-section views illustrating an outline of the structure of a space image forming element of a third embodiment of the present invention, and are a top view and a side view, respectively;

FIG. 11 is a cross-section view illustrating an outline of the structure of a space image forming element of a fourth embodiment of the present invention;

FIG. 12 is a manufacture process drawing illustrating an outline of process of manufacturing a space image forming element of a fifth embodiment of the present invention;

FIG. 13A is a cross-section view (top view) illustrating the operation principle of the space image forming element of the fifth embodiment of the present invention;

FIG. 13B is a cross-section view (side view) illustrating the operation principle of the space image forming element of the fifth embodiment of the present invention;

FIGS. 14A and 14B are top views illustrating the difference in operation principles depending on structures of the space image forming element; and

FIG. 15 is a cross-section view illustrating an outline of the structure of a terminal of the fifth embodiment of the present invention.

### DESCRIPTION OF EMBODIMENTS

Hereinafter, embodiments of the present invention will be specifically described with reference to the drawings.

### First Embodiment

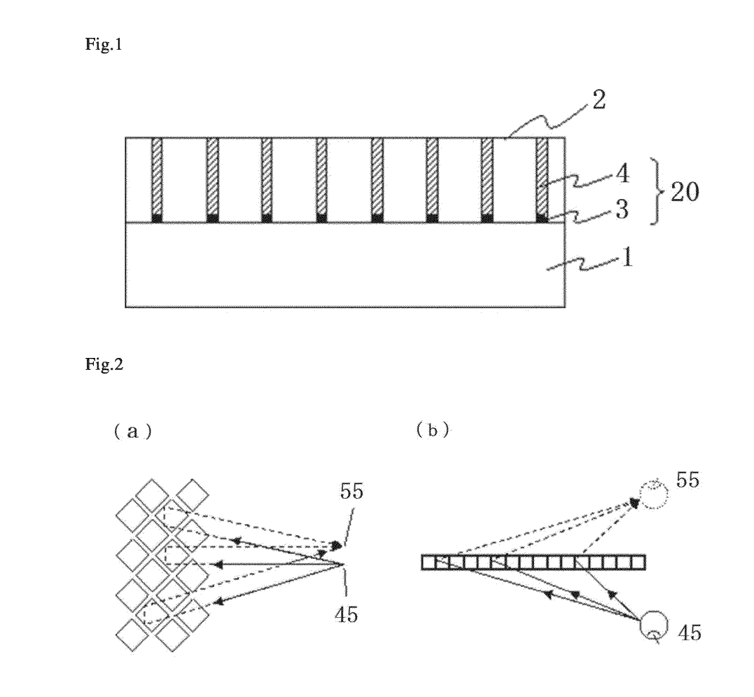

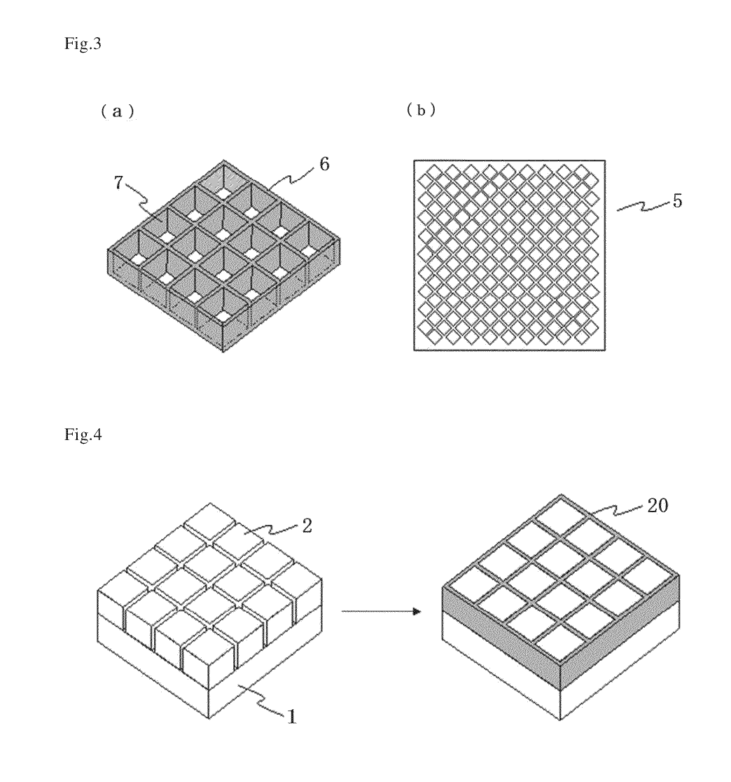

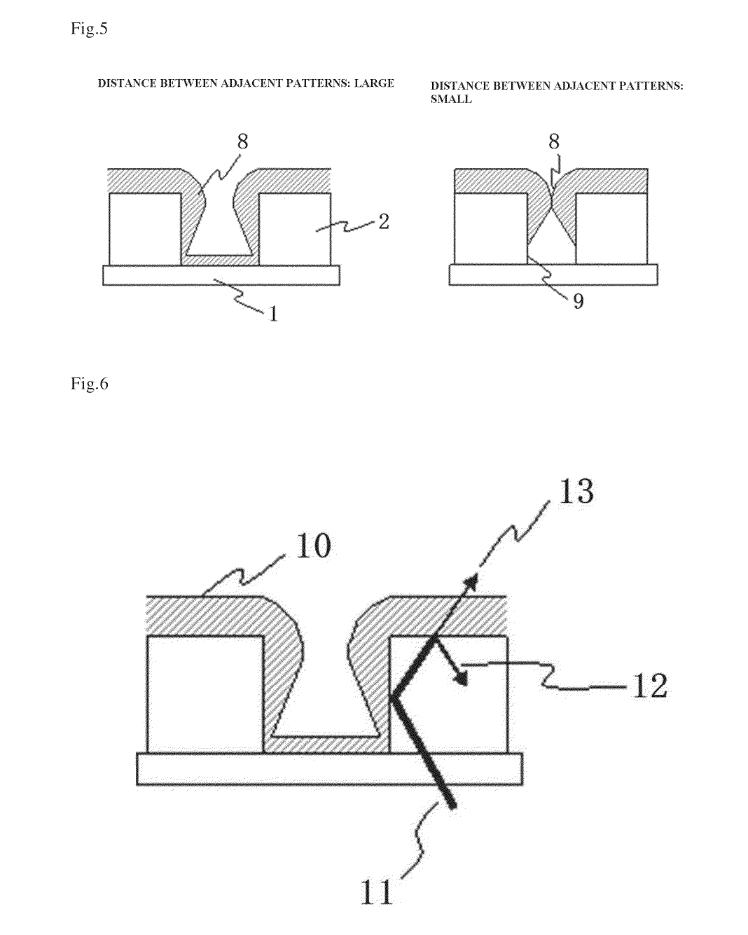

FIG. 1 is a cross-section view in the thickness direction of a space image forming element in an embodiment of the present invention.

A space image forming element of the embodiment has a transparent substrate 1. The transparent substrate 1 is made of glass or a resin such as PET (polyethylene terephthalate) or PC (polycarbonate).

In the same plane on the transparent substrate 1, transparent layers 2 disposed in a matrix and a pattern-shaped metal layer 20 partitioning the transparent layers 2 are provided. The metal layer 20 comprises two layers of a first metal layer 3 and a second metal layer 4.

As a proper shape, the transparent layer 2 has a height (thickness) which is properly in the range of 10 μm to 100 μm and is 40 μm in the first embodiment. The width of the transparent layer 2 is properly in the range of 10 μm to 100 μm in the surface of the transparent substrate 1 and is set to 40 μm in the first embodiment.

The width of the metal layer 20 is properly in the range of 1 μm to 30 μm in the surface of the transparent substrate 1 and is set to 10 μm in the first embodiment.

As will be described later, the first metal layer 3 has both the function of a photo mask for forming the transparent layer 2 and the function of an electrode at the time of forming the second metal layer 4 by electroplating. Consequently, shielding property from ultraviolet light as exposure light and conducting property to function as an electrode for electroplating are necessary. To assure adhesion strength of the second metal layer 4, the electrode for electroplating is preferably made of metal.

Although a conductive resin or the like may be used as a material having the conducting property, to assure sufficient strength of adhesion to the second metal layer 4 and to provide a mirror face having high reflectance in an interface with a transparent pattern side wall, a conductive metal needs to be used.

In the example of FIG. 1, the transparent layers 2 and the metal layers 20 are disposed as illustrated in FIG. 1. As a plane arrangement, the transparent layers 2 and the metal layers 20 are disposed so as to make a lattice-shaped plane pattern as illustrated in FIG. 4.

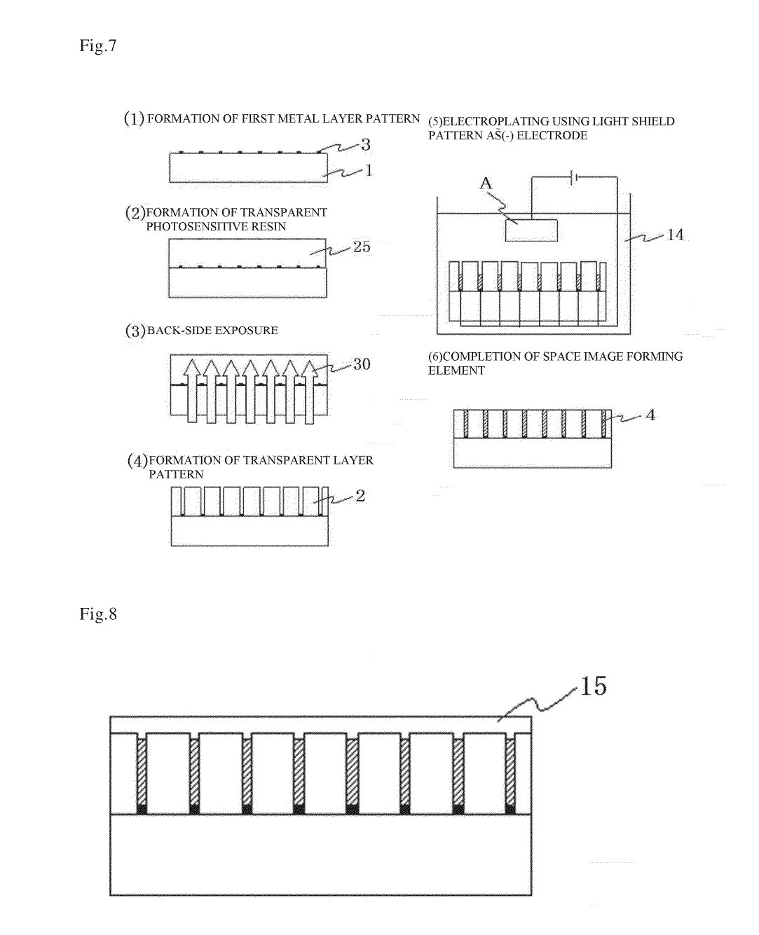

FIG. 7 illustrates process of manufacturing the space image forming element of the embodiment having the above-described configuration.

First, the pattern of the first metal layer 3 is formed on the surface of the transparent substrate 1 (refer to FIG. 7 (1)). The transparent substrate 1 is made of glass, PET (polyethylene terephthalate) or PC (polycarbonate).

The first metal layer 3 is made of chromium, aluminum or nickel as a metal having both shielding property and conducting property, an alloy whose main component is any of the metals, or the like. The width of the first metal layer 3 is properly in the range of 1 μm to 30 μm in the surface of the transparent substrate 1 and is set to 10 μm in the embodiment.

The film thickness of the second metal layer 4 is properly in the range of 0.1 μm to 0.4 μm and is set to 0.2 μm in the embodiment. Subsequently, a transparent photosensitive resin 25 is formed on the surface of the transparent substrate 1 (refer to FIG. 7 (2)). As the transparent photosensitive resin 25, chemically-amplified photoresist (trade name: SU-8) manufactured by MicroChem Corp. is used.

The transparent photosensitive resin 25 is a negative resist of an epoxy base (concretely, glycidyl ether derivative of bisphenol A novolac) which is irradiated with ultraviolet light so that acid is produced by a photo initiator and which polymerizes curable monomer using the protonic acid as a catalyst. The transparent photosensitive resin 25 has a characteristic of very high transparency in a visual light range.

Since the molecule weight before curing of the curable monomer contained in the transparent photosensitive resin 25 is relatively small, the curable monomer is dissolved very easily in a solvent such as cyclopentanone, PEGMEA (propylene glycol methyl ether acetate), GBL (gamma butyl lactone), or MIBK (methyl isobutyl ketone), so that a thick film can be easily formed.

Further, the transparent photosensitive resin 25 has high light transmission also at wavelengths in the near-ultraviolet range, and therefore, has a characteristic that it transmits ultraviolet rays even the film made thereof is thick.

As a method of forming the transparent photosensitive resin 25, for example, a film forming method such as a slit die coater, a wire coater, an applicator, dry film transfer, a spray coating, or the like can be used.

Since the transparent photosensitive resin 25 has such a characteristic, a pattern having high aspect ratio which is three or higher can be also formed. Further, a number of functional groups exist in the curable monomer, so that, after curing, the transparent photosensitive resin 25 becomes a cross-link having very high density and has a characteristic that it is thermally and chemically highly stable. Consequently, the transparent photosensitive resin 25 is easily processed after pattern formation.

Obviously, the transparent photosensitive resin 25 used in the present invention is not limited to the above-described transparent photosensitive resin (trade name: SU-8). Any light curing material may be used as long as it has similar characteristics.

Subsequently, the pattern of the first metal layer 3 is used as a mask for exposure and the back side of the transparent photosensitive resin 25, which is the face opposite to the face on which the resin of the transparent substrate 1 is formed, is exposed to light (refer to FIG. 7 (3)).

A UV light source is used as the light source, and UV light having a wavelength of 365 nm is emitted as exposure rays 30. The exposure amount in this case lies in the range of 50 mJ/cm² to 500 mJ/cm² and is set to 300 mJ/cm² in the embodiment. By performing exposure and development, the transparent layer 2 is formed (refer to FIG. 7 (4)).

As the shape of the transparent layer 2, the height (thickness) is properly in the range of 10 μm to 100 μm and is set to 40 μm in the first embodiment. The width of the transparent layer 2 is properly in the range of 10 μm to 100 μm and is set to 40 μm in the first embodiment.

Subsequently, by electroplating to an anode A using the first metal layer 3 as a cathode, the second metal layer 4 is formed on the first metal layer 3. The second metal layer 4 is made of nickel (Ni), nickel palladium (NiPd), nickel cobalt (NiCo), or the like and, in the embodiment, is made of nickel (refer to FIG. 7 (5)). As a result, a space image forming element in the embodiment is obtained (refer to FIG. 7 (6)).

### Second Embodiment

FIG. 8 is a cross-section view of a space image forming element in a second embodiment of the present invention. For simplicity, description will be given using the same reference numerals as those of the first embodiment as reference numerals of a substrate and the like.

A cover layer 15 is disposed on the transparent layers 2 and the second metal layers 4 formed on the transparent substrate 1 in a manner similar to the first embodiment. The thickness of the cover layer 15 is 5 μm to 30 μm and is set to 10 μm in the embodiment. To prevent scattering of light in the surface of the cover layer 15, surface roughness is set to 2 μm or less and is set to 1 μm in the embodiment.

As the cover layer 15, the transparent photosensitive resin 25 (trade name: SU-8) manufactured by MicroChem Corp. which is the same as that of the transparent layer 2 is used. The refractive index of the transparent photosensitive resin (trade name: SU-8) is 1.58, and the refractive index of the transparent layer 2 and that of the cover layer 15 are the same. By making the transparent layer 2 and the cover layer 15 of the same material, light is not reflected in the interface of the layers, so that deterioration in the transmittance is prevented. Obviously, the cover layer 15 used in the present invention is not limited to the transparent photosensitive resin (trade name: SU-8) but any material may be used as long as it has similar optical characteristics (refractive index, transmittance, and the like). The resin curing means is not limited to light curing resin but may be thermal curing resin.

As the method of forming the cover layer 15, for example, a film forming method such as a slit die coater, a wire coater, an applicator, dry film transfer, or spray coating may be used.

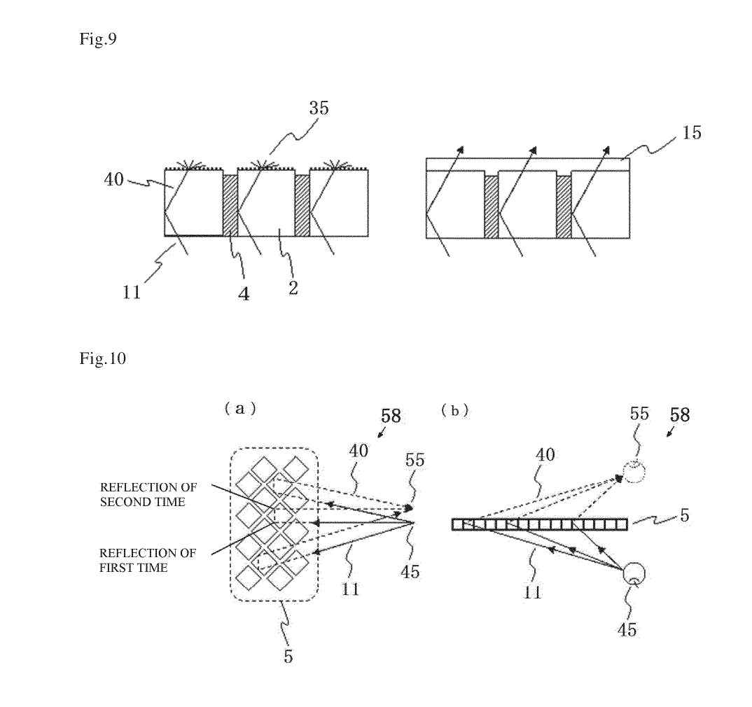

As illustrated in FIG. 9, when the surface of the transparent layer 2 is uneven, scattering light 35 of reflection light 40 is generated and it causes disturbance in a space image. On the other hand, when the cover layer 15 of the embodiment is formed, the roughness in the surface of the transparent layer 2 is covered, so that the reflection light 40 goes out without being scattered. Therefore, a clear space image is obtained.

### Third Embodiment

FIGS. 10A and 10B illustrate the configuration of a display device 58 in a third embodiment of the present invention. Below the space image forming element 5 of the first and second embodiments, a light source 45 having a display face displaying an image as a projected object is disposed.

By making a projection image from the light source 45 reflected twice in total, by each of two light reflection faces of the space image forming element 5, an image 55 formed in a plane-symmetrical position using the space image forming element 5 as a symmetrical plane can be obtained.

### Fourth Embodiment

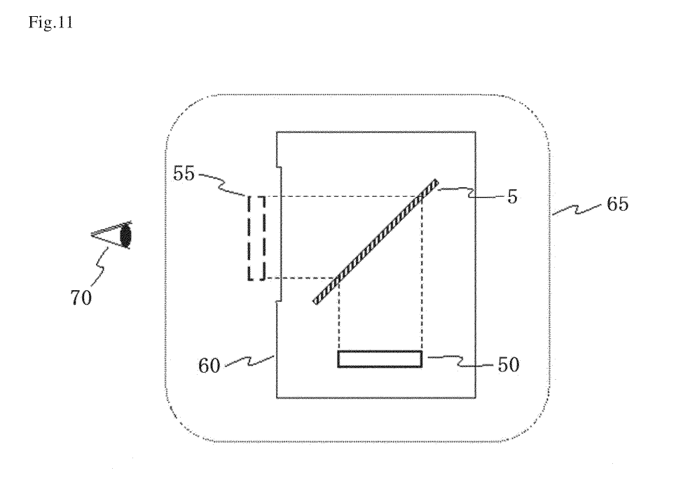

FIG. 11 illustrates the configuration of a terminal 65 in a fourth embodiment of the present invention. In a casing 60, the space image forming element 5 of the first and second embodiments and a display 50 having a display face displaying an image as a projected object are disposed.

An image 55 formed by making the projected image from the display 50 reflected by the light reflection area of the space image forming element 5 is obtained on the outside of the casing 60. From the position of an observer 70, the image 55 formed on the outside of the casing 60 is seen.

### Fifth Embodiment

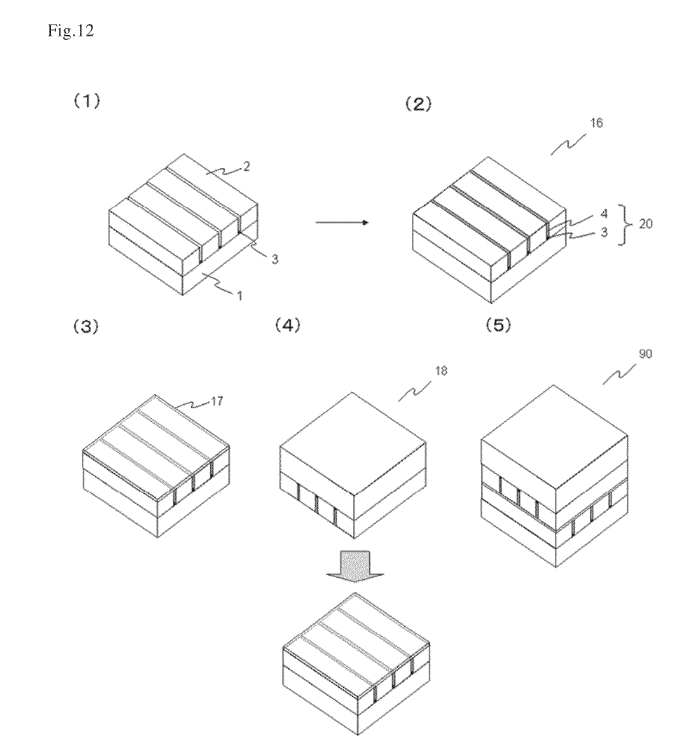

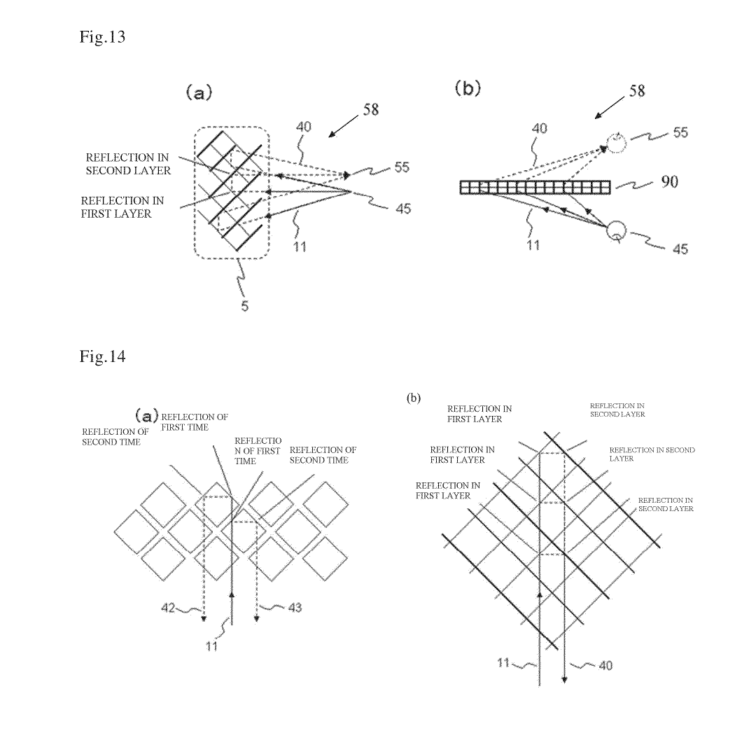

FIG. 12 and FIGS. 13A and 13B illustrate process of manufacturing a space image forming element in a fifth embodiment of the present invention. For simplicity, the same reference numerals as those of the first embodiment are designated to the substrate and the like.

The transparent layer 2 and the first metal layer 3 formed on the transparent substrate 1 in a manner similar to the first embodiment are disposed (refer to FIG. 12 (1)). In a manner similar to the first embodiment, by forming the second metal layer 4 on the first metal layer 3, a first structure 16 in which the metal layer 20 is disposed is configured (refer to FIG. 12 (2)). In plane arrangement of the transparent layer 2 and the metal layer 20, a striped plane pattern as illustrated in FIG. 12 (2) is formed. Subsequently, a transparent adhesive layer 17 is disposed on the transparent layer 2 and the second metal layer 4 of the first structure 16 (refer to FIG. 12 (3)). The thickness of the transparent adhesive layer 17 is 5 μm to 20 μm and is set to 10 μm in the embodiment.

As the transparent adhesive layer 17, the transparent photosensitive resin (trade name: SU-8) manufactured by MicroChem Corp. which is the same as that of the transparent layer 2 is used. The refractive index of the transparent photosensitive resin (trade name: SU-8) is 1.58, and the refractive index of the transparent layer 2 and that of the transparent adhesive layer 17 are the same. By making the transparent layer 2 and the transparent adhesive layer 17 of the same material, light is not reflected in the interface of the layers, so that the transmittance is held. Obviously, the transparent adhesive layer 17 used in the present invention is not limited to the transparent photosensitive resin (trade name: SU-8) but any material may be used as long as it has similar refractive index. In curing of the resin performed in FIG. 12(4), the curing means is not limited to light curing but may be thermal curing.

As the method of forming the transparent adhesive layer 17, for example, a film forming method such as a slit die coater, a wire coater, an applicator, dry film transfer, or spray coating may be used.

Next, a second structure 18 having the same configuration as that of the first structure 16 is manufactured, and another structure 18 is disposed on the transparent adhesive layer 17 so that the first and second structures 16 and 18 are deviated from each other by 90 degrees (refer to FIG. 12 (4)). Subsequently, by making the transparent adhesive layer 17 cured, a space image forming element 90 is obtained (refer to FIG. 12 (5)).

As illustrated in FIGS. 13A and 13B, below the space image forming element 90 obtained as described above, the light source 45 displaying an image as a projected image is disposed. By making a projection image from the light source 45 reflected twice in total, by each of two light reflection faces in the first and second layers of the space image forming element 90, the image 55 formed in a plane-symmetrical position using the space image forming element 90 as a symmetrical plane can be obtained.

As illustrated in FIG. 14A, in a space image forming element whose light reflection face has a lattice pattern, there is the possibility that incident light 11 is split to two reflection rays of a reflection ray “a” 42 and a reflection ray “b” 43 depending on the incidence position of the incident light 11. On the other hand, as illustrated in FIG. 14B, in the space image forming element having a structure in which the striped light reflection faces in two layers are turned from each other by 90 degrees, the incident light 11 is one without depending on the incidence position. Consequently, a clearer space image is obtained.

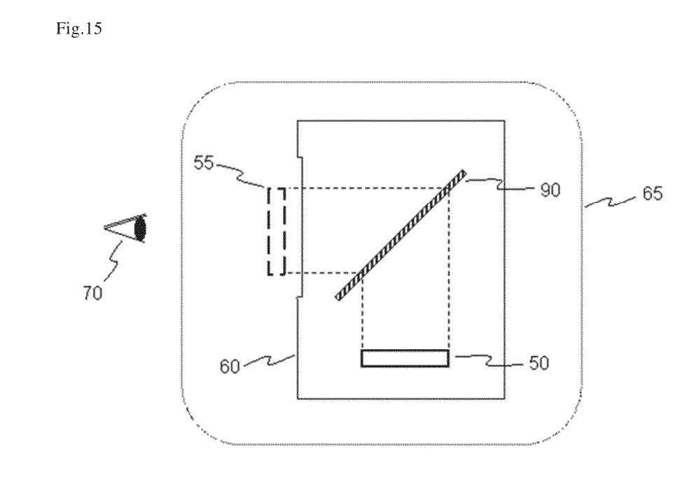

FIG. 15 illustrates the configuration of the terminal 65 in the fifth embodiment of the present invention. In the casing 60, the space image forming element 90 according to the fifth embodiment and the display 50 having a display face displaying an image as a projection image are disposed.

The image 55 formed by making the projection image from the display 50 reflected by the light reflection face of the space image forming element 90 is obtained on the outside of the casing 60. From the position of the observer 70, the image 55 formed on the outside of the casing 60 is seen.

What is claimed is:

1. A method of manufacturing a space image forming element, comprising:
a step of forming a transparent photosensitive resin on a transparent substrate on which a first conductor is formed;
a step of forming a light transmission region made by patterning the transparent photosensitive resin, on the transparent substrate other than a place where the first conductor is formed, by ultraviolet light irradiation to a face opposite to the transparent substrate face obtained by forming the transparent photosensitive resin and a subsequent developing process; and
a step of forming a second conductor on the first conductor and between light transmission region patterns by electroplating using the first conductor as a cathode.

2. The method of manufacturing a space image forming element according to claim 1, wherein the first conductor has shielding property from ultraviolet rays.

3. The method of manufacturing a space image forming element according to claim 1, wherein the first conductor is made of a metal.

4. The method of manufacturing a space image forming element according to claim 3, wherein the metal of the first conductor is nickel, aluminum, chromium, or an alloy whose main component is any of the metals.

5. The method of manufacturing a space image forming element according to claim 1, wherein the second conductor is a metal.

6. The method of manufacturing a space image forming element according to claim 5, wherein the metal of the second conductor is nickel, nickel palladium, or nickel cobalt.

7. The method of manufacturing a space image forming element according to claim 1, wherein a cover layer is disposed on the surface of the light transmission region and the second conductor, and
the surface of the cover layer has a flat shape.

8. The method of manufacturing a space image forming element according to claim 7, wherein the cover layer is made of a transparent resin having the same refractive index as that of the light transmission region.

9. A space image forming element manufactured by the manufacturing method according to claim 1.

10. A display device comprising:
the space image forming element according to claim 9; and
a display disposed below the space image forming element and having a display face displaying an image as a projected object,
wherein the image is reflected twice by an interface between the first conductor or the second conductor and the light transmission region of the space image forming element, and then formed in a plane-symmetrical position using the space image forming element as a symmetrical plane, there being displayed as an image.

11. A method of manufacturing a space image forming element, comprising:
a step of forming a transparent photosensitive resin on a transparent substrate on which a first conductor in a stripe pattern is formed;
a step of forming a light transmission region made by patterning the transparent photosensitive resin, on the transparent substrate other than a place where the first conductor is formed, by ultraviolet light irradiation to a face opposite to the transparent substrate face obtained by forming the transparent photosensitive resin and a subsequent developing process;
a step of obtaining a first structure by forming a second conductor on the first conductor and between the light transmission region patterns by electroplating using the first conductor as a cathode;
a step of obtaining a second structure by performing the same process as that of the first structure;
a step of forming a transparent adhesive layer on the second conductor and the light transmission region of the first structure;
a step of disposing the second structure on the transparent adhesive layer so that the first and second structures are turned from each other by 90 degrees; and
a step of making the transparent adhesive layer cured.

12. The method of manufacturing a space image forming element according to claim 11, wherein the transparent adhesive layer is made of a transparent resin having the same refractive index as that of the light transmission region.

13. A space image forming element manufactured by the manufacturing method according to claim 11.

14. A display device comprising:
the space image forming element according to claim 13; and
a display disposed below the space image forming element and having a display face displaying an image as a projected object,
wherein the image is reflected by an interface between the first conductor or the second conductor and the light transmission region of the first structure of the space image forming element, reflected by an interface between the first conductor or the second conductor and the light transmission region of the second structure, and then formed in a plane-symmetrical position using the space image forming element as a symmetrical plane, thereby being displayed as an image.

15. A terminal having the display device according to claim 10.

16. A terminal having the display device according to claim 14.
